(19) United States
(12) Patent Application Publication
(10) Pub. No.: US 2025/0168775 A1
(43) Pub. Date: May 22, 2025

(54) USER EQUIPMENT SELECTED MAXIMUM OUTPUT POWER FOR SIMULTANEOUS TRANSMISSIONS

(71) Applicant: QUALCOMM INCORPORATED, San Diego, CA (US)

(72) Inventors: Mostafa Khoshnevisan, San Diego, CA (US); Fang Yuan, Beijing (CN); Jing Sun, San Diego, CA (US); Tao Luo, San Diego, CA (US)

(21) Appl. No.: 18/835,290

(22) PCT Filed: Mar. 16, 2022
(86) PCT No.: PCT/CN2022/081107

§ 371 Date: Aug. 1, 2024

(51) Int. Cl. H04W 52/14; H04W 52/36

(52) U.S. Cl. CPC H04W 52/146; H04W 52/367

(57) ABSTRACT

Methods, systems, and devices for wireless communication are described. A user equipment (UE) may receive a control message scheduling a plurality of time-domain overlapping uplink transmissions by the UE on an uplink component carrier. The UE may select a transmission power for each uplink transmission in the plurality of time-domain overlapping uplink transmissions, wherein selecting the transmission power for each uplink transmission includes scaling one or more of a maximum transmission power for each uplink transmission or an actual transmission power for each uplink transmission, the scaling based at least in part on a numerical quantity of the uplink transmissions in the plurality of time-domain overlapping uplink transmissions. The UE may perform the plurality of time-domain overlapping uplink transmissions on the uplink component carrier according to the selected transmission power for each uplink transmission.

### CROSS REFERENCE

The present application is a 371 national stage filing of International PCT Application No. PCT/CN2022/081107 by Khoshnevisan et al. entitled “USER EQUIPMENT SELECTED MAXIMUM OUTPUT POWER FOR SIMULTANEOUS TRANSMISSIONS,” filed Mar. 16, 2022, which is assigned to the assignee hereof, and which is expressly incorporated by reference in its entirety herein.

### FIELD OF TECHNOLOGY

The following relates to wireless communication, including user equipment (UE) selected maximum output power for simultaneous transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support user equipment (UE) selected maximum output power for simultaneous transmissions. For example, the described techniques provide various mechanisms supporting a UE selecting the transmission power for each uplink transmission in a multi-uplink transmission scenario. The UE may receive control signaling scheduling a plurality of uplink transmissions by the UE. In some aspects, the plurality of uplink transmissions may be time domain overlapping uplink transmissions (e.g., on a per UE panel, such as an antenna panel configuration of the UE, per control resource set (CORESET) pool index, per transmission/reception point (TRP), per cell, per beam, etc.). The UE may select the transmission power for each uplink transmission by scaling the actual or maximum transmission power of each uplink transmission. For example, the UE may scale the transmission power based on how many (e.g., the numerical quantity) uplink transmissions are being performed. In some examples, the scaling may be based on a maximum transmission power on a per-uplink transmission basis. Accordingly, the UE may perform the plurality of uplink transmissions overlapping in the time domain according to the selected transmission power (e.g., selected for each uplink transmission) to the network entity.

A method for wireless communication at a UE is described. The method may include receiving a control message scheduling a set of multiple time-domain overlapping uplink transmissions by the UE on an uplink component carrier, selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions, and performing the set of multiple time-domain overlapping uplink transmissions on the uplink component carrier according to the selected transmission power for each uplink transmission.

An apparatus for wireless communication at a UE is described. The apparatus may include a processor, memory coupled with the processor, and instructions stored in the memory. The instructions may be executable by the processor to cause the apparatus to receive a control message scheduling a set of multiple time-domain overlapping uplink transmissions by the UE on an uplink component carrier, select a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions, and perform the set of multiple time-domain overlapping uplink transmissions on the uplink component carrier according to the selected transmission power for each uplink transmission.

Another apparatus for wireless communication at a UE is described. The apparatus may include means for receiving a control message scheduling a set of multiple time-domain overlapping uplink transmissions by the UE on an uplink component carrier, means for selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions, and means for performing the set of multiple time-domain overlapping uplink transmissions on the uplink component carrier according to the selected transmission power for each uplink transmission.

A non-transitory computer-readable medium storing code for wireless communication at a UE is described. The code may include instructions executable by a processor to receive a control message scheduling a set of multiple time-domain overlapping uplink transmissions by the UE on an uplink component carrier, select a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions, and perform the set of multiple time-domain overlapping uplink transmissions on the uplink component carrier according to the selected transmission power for each uplink transmission.

In some examples of the method, apparatuses, and non-transitory computer-readable medium described herein, selecting the transmission power for each uplink transmission in the set of multiple time-domain overlapping uplink transmissions may include operations, features, means, or instructions for identifying a maximum available transmission power for the uplink component carrier and capping the transmission power for each uplink transmission to limit a sum of the actual transmission power for each uplink transmission within the maximum available transmission power.

In some examples of the method, apparatuses, and non-transitory computer-readable medium described herein, capping the actual transmission power may include operations, features, means, or instructions for equally dividing the maximum available transmission power among each uplink transmission in the set of multiple time-domain overlapping uplink transmissions.

In some examples of the method, apparatuses, and non-transitory computer-readable medium described herein, capping the actual transmission power may include operations, features, means, or instructions for assigning a weighting factor to each uplink transmission and capping the actual transmission power for each uplink transmission according to the assigned weighting factor.

Some examples of the method, apparatuses, and non-transitory computer-readable medium described herein may further include operations, features, means, or instructions for capping the actual transmission power may be based on an overlap between the uplink transmissions in a time domain.

Some examples of the method, apparatuses, and non-transitory computer-readable medium described herein may further include operations, features, means, or instructions for capping the actual transmission power may be independent from an overlap between the uplink transmissions in a time domain.

Some examples of the method, apparatuses, and non-transitory computer-readable medium described herein may further include operations, features, means, or instructions for receiving a signal configuring a maximum allowable transmission power for the each uplink transmission.

Some examples of the method, apparatuses, and non-transitory computer-readable medium described herein may further include operations, features, means, or instructions for cancelling one or more of the uplink transmissions based on a sum of the actual transmission power for each uplink transmission failing to satisfy a maximum available transmission power for the uplink component carrier.

Some examples of the method, apparatuses, and non-transitory computer-readable medium described herein may further include operations, features, means, or instructions for scaling down the actual transmission power of each uplink transmission based on a sum of the actual transmission power for each uplink transmission failing to satisfy a maximum available transmission power for uplink component carrier.

Some examples of the method, apparatuses, and non-transitory computer-readable medium described herein may further include operations, features, means, or instructions for scaling down the actual transmission power of one or more of the uplink transmissions based on a sum of the actual transmission power for each uplink transmission failing to satisfy a maximum available transmission power for the uplink component carrier.

Some examples of the method, apparatuses, and non-transitory computer-readable medium described herein may further include operations, features, means, or instructions for scaling the transmission power for each uplink transmission according to a maximum available transmission power for each uplink transmission.

Some examples of the method, apparatuses, and non-transitory computer-readable medium described herein may further include operations, features, means, or instructions for identifying the maximum available transmission power for each uplink transmission and scaling up the maximum transmission power for each uplink transmission to the maximum available transmission power.

Some examples of the method, apparatuses, and non-transitory computer-readable medium described herein may further include operations, features, means, or instructions for identifying the maximum available transmission power for each uplink transmission based on a power class associated with time-domain overlapping uplink transmissions and scaling the maximum transmission power for each uplink transmission to the maximum available transmission power.

Some examples of the method, apparatuses, and non-transitory computer-readable medium described herein may further include operations, features, means, or instructions for receiving a signal configuring the maximum allowable transmission power for each uplink transmission based on the power class.

In some examples of the method, apparatuses, and non-transitory computer-readable medium described herein, each uplink transmission in the set of multiple time-domain overlapping uplink transmissions may be associated with at least one of an antenna panel configuration of the UE, a control resource set pool index value of the UE, a node receiving the uplink transmission, a beam being used for the uplink transmission, or any combination thereof.

A method for wireless communication at a network entity is described. The method may include transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions and receiving one or more uplink transmissions of the set of multiple time-domain overlapping uplink transmissions on the uplink component carrier according to the selected transmission power for each uplink transmission.

An apparatus for wireless communication at a network entity is described. The apparatus may include a processor, memory coupled with the processor, and instructions stored in the memory. The instructions may be executable by the processor to cause the apparatus to transmit a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions and receive one or more uplink transmissions of the set of multiple time-domain overlapping uplink transmissions on the uplink component carrier according to the selected transmission power for each uplink transmission.

Another apparatus for wireless communication at a network entity is described. The apparatus may include means for transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions and means for receiving one or more uplink transmissions of the set of multiple time-domain overlapping uplink transmissions on the uplink component carrier according to the selected transmission power for each uplink transmission.

A non-transitory computer-readable medium storing code for wireless communication at a network entity is described. The code may include instructions executable by a processor to transmit a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions and receive one or more uplink transmissions of the set of multiple time-domain overlapping uplink transmissions on the uplink component carrier according to the selected transmission power for each uplink transmission.

Some examples of the method, apparatuses, and non-transitory computer-readable medium described herein may further include operations, features, means, or instructions for transmitting a signal identifying a maximum available transmission power for the uplink component carrier, where the selected transmission power for each uplink transmission may be based on the maximum available transmission power.

Some examples of the method, apparatuses, and non-transitory computer-readable medium described herein may further include operations, features, means, or instructions for transmitting a signal identifying a weighting factor for each uplink transmission.

Some examples of the method, apparatuses, and non-transitory computer-readable medium described herein may further include operations, features, means, or instructions for transmitting a signal identifying a maximum available transmission power each uplink transmission, where the selected transmission power for each uplink transmission may be based on the maximum available transmission power.

### BRIEF DESCRIPTION OF THE DRAWINGS

FIG. 1 illustrates an example of a wireless communications system that supports user equipment configured maximum output power for simultaneous transmissions in accordance with one or more aspects of the present disclosure.

FIG. 2 illustrates an example of a wireless communications system that supports user equipment configured maximum output power for simultaneous transmissions in accordance with one or more aspects of the present disclosure.

FIG. 3 illustrates an example of a process that supports user equipment configured maximum output power for simultaneous transmissions in accordance with one or more aspects of the present disclosure.

FIGS. 4 and 5 show block diagrams of devices that support user equipment configured maximum output power for simultaneous transmissions in accordance with one or more aspects of the present disclosure.

FIG. 6 shows a block diagram of a communications manager that supports user equipment configured maximum output power for simultaneous transmissions in accordance with one or more aspects of the present disclosure.

FIG. 7 shows a diagram of a system including a device that supports user equipment configured maximum output power for simultaneous transmissions in accordance with one or more aspects of the present disclosure.

FIGS. 8 and 9 show block diagrams of devices that support user equipment configured maximum output power for simultaneous transmissions in accordance with one or more aspects of the present disclosure.

FIG. 10 shows a block diagram of a communications manager that supports user equipment configured maximum output power for simultaneous transmissions in accordance with one or more aspects of the present disclosure.

FIG. 11 shows a diagram of a system including a device that supports user equipment configured maximum output power for simultaneous transmissions in accordance with one or more aspects of the present disclosure.

FIGS. 12 through 16 show flowcharts illustrating methods that support user equipment configured maximum output power for simultaneous transmissions in accordance with one or more aspects of the present disclosure.

### DETAILED DESCRIPTION

A network entity may generally manage one or more aspects of configuring a user equipment (UE) for an uplink transmission. For example, the network entity may configure resources in the time domain, frequency domain, spatial domain, and/or code domain for the uplink transmission. The network entity may also schedule various transmission parameters for the uplink transmission, such as hybrid automatic repeat/request-acknowledgement (HARQ-ACK) feedback, an actual and/or maximum transmission power limit for the uplink transmission, and the like. Advanced wireless communication systems/UE may permit scheduling the UE to perform multiple uplink transmissions (e.g., some of which may overlap in the time domain). However, conventional techniques may not provide a mechanism for the UE to select the transmission power for each uplink transmission in the situation where the UE is performing multiple uplink transmissions at the same time.

For example, the described techniques provide various mechanisms supporting a UE selecting the transmission power for each uplink transmission in a multi-uplink transmission scenario. The UE may receive control signaling scheduling a plurality of uplink transmissions by the UE. In some aspects, the plurality of uplink transmissions may be time domain overlapping uplink transmissions (e.g., on a per UE panel, such as an antenna panel configuration of the UE, per control resource set (CORESET) pool index, per transmission/reception point (TRP), per cell, per beam, etc.). The UE may select the transmission power for each uplink transmission by scaling the actual or maximum transmission power of each uplink transmission. For example, the UE may scale the transmission power based on how many (e.g., the numerical quantity) uplink transmissions are being performed. In some examples, the scaling may be based on a maximum transmission power on a per-uplink transmission basis. Accordingly, the UE may perform the plurality of uplink transmissions overlapping in the time domain according to the selected transmission power (e.g., selected for each uplink transmission) to the network entity.

Aspects of the disclosure are initially described in the context of wireless communications systems. Aspects of the disclosure are further illustrated by and described with reference to apparatus diagrams, system diagrams, and flowcharts that relate to user equipment configured maximum output power for simultaneous transmissions.

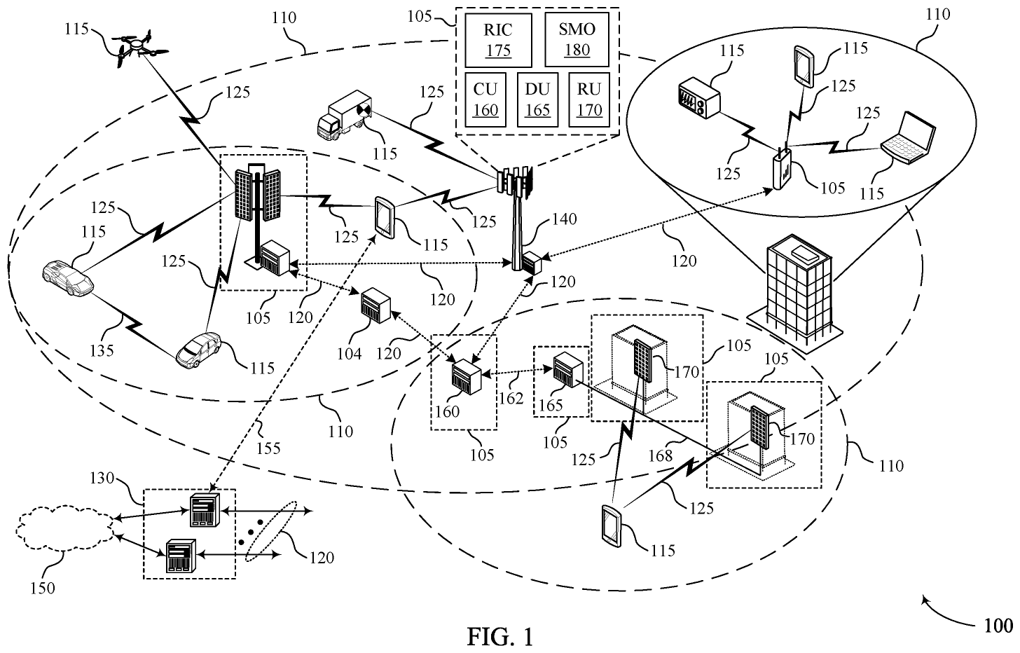

FIG. 1 illustrates an example of a wireless communications system 100 that supports user equipment configured maximum output power for simultaneous transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support user equipment configured maximum output power for simultaneous transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 may receive a control message scheduling a plurality of time-domain overlapping uplink transmissions by the UE 115 on an uplink CC. The UE 115 may select a transmission power for each uplink transmission in the plurality of time-domain overlapping uplink transmissions, wherein selecting the transmission power for each uplink transmission includes scaling one or more of a maximum transmission power for each uplink transmission or an actual transmission power for each uplink transmission, the scaling based at least in part on a numerical quantity of the uplink transmissions in the plurality of time-domain overlapping uplink transmissions. The UE 115 may perform the plurality of time-domain overlapping uplink transmissions on the uplink CC according to the selected transmission power for each uplink transmission.

A network entity 105 may transmit a control message scheduling a plurality of time-domain overlapping uplink transmissions by a UE 115 on an uplink CC, wherein a transmission power for each uplink transmission in the plurality of time-domain overlapping uplink transmissions is selected by scaling one or more of a maximum transmission power for each uplink transmission or an actual transmission power for each uplink transmission, the scaling based at least in part on a numerical quantity of the uplink transmissions in the plurality of time-domain overlapping uplink transmissions. The network entity 105 may receive one or more uplink transmissions of the plurality of time-domain overlapping uplink transmissions on the uplink CC according to the selected transmission power for each uplink transmission.

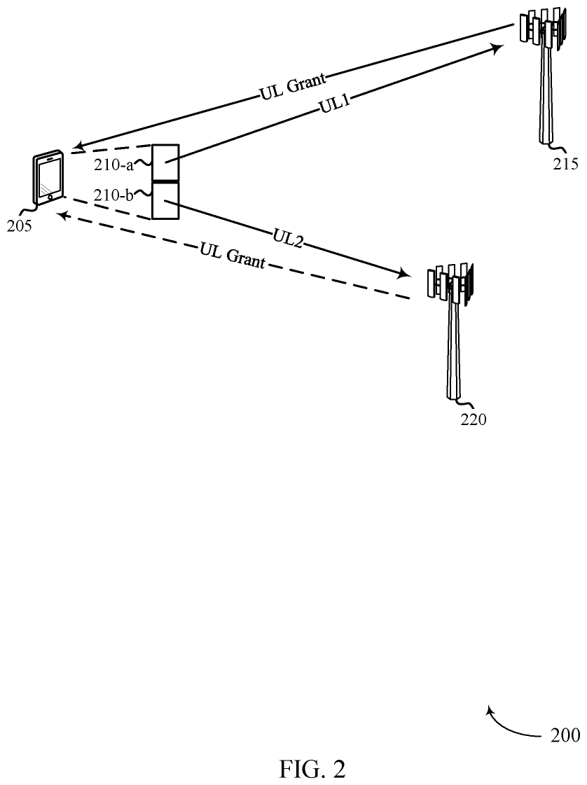

FIG. 2 illustrates an example of a wireless communications system 200 that supports UE selected maximum output power for simultaneous transmissions in accordance with one or more aspects of the present disclosure. Wireless communications system 200 may include UE 205, network entity 215, and network entity 220, which may be examples of the corresponding devices described herein.

Conventional networks generally provide for a network entity, such as network entity 215 in this example, to manage configuring UE 205 for an uplink transmission (e.g., using an uplink grant, such as a DCI format 0_0/1 uplink grant). For example, network entity 215 may configure resources in the time domain, frequency domain, spatial domain, and/or code domain for the uplink transmission to be performed by UE 205. Network entity 215 may also schedule various transmission parameters for the uplink transmission, such as HARQ-ACK feedback, an actual and/or maximum transmission power limit for the uplink transmission, and the like.

For example, UE 205 may conventionally be configured with a maximum output power (e.g., a maximum transmission power) for the uplink transmission. The uplink transmission in this example may include one or more of a physical uplink shared channel (PUSCH) transmission, a physical uplink control channel (PUCCH) transmission, a sounding reference signal (SRS) transmission, a physical random access channel (PRACH) transmission, and the like. In some aspects, the maximum output power may be configured for a CC that the uplink transmission is being performed on. For example, the transmission power may be configured according to:

$${P}_{PUSCH , b , f , c} ( i , j , {q}_{d} , l ) = min \{ \begin{matrix}{P}_{Cmax , f , c} ( i ) \\ \begin{matrix}{P}_{{0}_{- PUSCH , b , f , c}} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f . c} ( i , l )\end{matrix}\end{matrix}$$

In some aspects, P_{Cmax,f,c}(i) may be the UE selected maximum output power for carrier f of service cell c in/during PUSCH occasion i. Accordingly, UE 205 may calculate, select, or otherwise determine the power for the uplink transmission (e.g., PUSCH/PUCCH/SRS/PRACH) in consideration of the maximum transmission power being set by P_{Cmax,f,c}. Generally, this maximum transmission power (e.g., the maximum output power) is identified, set, selected, or otherwise determined by UE 205 (e.g., autonomously). In some examples, the maximum transmission power may be subject to certain conditions set by UE 205 and/or based on RRC configuration signaling received by UE 205 (e.g., such as when the uplink transmission occurs in frequency range one (FR1)). In some examples, the conditions (autonomously selected and/or otherwise configured) may depend on the FR being used for the uplink transmission, the power class of UE 205, and the like.

For example, UE 205 may identify, select, or otherwise determine its configured maximum output power P_{Cmax,f,c} for carrier f (e.g., uplink CC f), of serving cell c in each slot. Broadly, the configured maximum output power P_{Cmax,f,c} may be set within bounds, such as P_{Cmax_L,f,c}≤P_{Cmax,f,c}≤P_{Cmax}_{_{H}}_{,f,c}. In some aspects, P_{Cmax_L,f,c} is based on:

P_{Cmax_L,f.c}=MIN{P_{EMAC,c}−ΔT_{C,c,}(P_{PowerClass}−ΔP_{PowerClass})−MAX(MAX(MPR_{c}+ΔMPR_{c},A−MPR_{c})+ΔT_{IB,c}+ΔT_{C,c}+ΔT_{RxSRS},P−MPR_{c})}

And P_{Cmax_H,f,c} is based on:

P_{Cmax_H,f,c}=MIN{P_{EMAX,c},P_{PowerClass}−ΔP_{PowerClass}}

In some aspects, P_{EMAX,c} may be RRC configured using p-MAX information element (IE) indication and/or the NR-NS-PmaxList IE. In some aspects, P_{EMAX,c} may be configured on a per-uplink carrier and/or on a per uplink serving cell basis (e.g., indicated in the FrequencyInfoUL sequence), where P-Max may correspond to an integer value of (−30 . . . 33).

Broadly, the P_{PowerClass} may correspond to the maximum UE power specified in RRC configuration signaling, without considering the tolerance values. Table 1 below indicates one non-limiting example of a table configuring power classes.

TABLE 1

| | | | | | | | | |
|---|---|---|---|---|---|---|---|---|
| NR | Class1 | Tolerance | Class 1.5 | Tolerance | Class 2 | Tolerance | Class 3 | Tolerance |
| Band | (dBm) | (dB) | (dBm) | (dB) | (dBM) | (dB) | (dBm) | (dB) |

| | | | | |
|---|---|---|---|---|
| n1 | | | 23 | ±2 |
| n2 | | | 23 | ±2³ |
| n3 | | | 23 | ±2³ |
| n5 | | | 23 | ±2 |
| n7 | | | 23 | ±2³ |
| n8 | | | 23 | ±2³ |
| n12 | | | 23 | ±2³ |
| n13 | | | 23 | ±2 |
| n14 | 31⁶ | +2/−3 | 23 | ±2 |

When the uplink transmissions occur in FR2, other considerations may be employed when UE 205 is configuring its maximum transmission power. For example, UE 205 may select the maximum output power P_{Cmax,f,c} for carrier f of a serving cell c such that the corresponding measured peak effective isotropic radiated power (EIRP) (P_{UMAX,f,c}) is within the following bounds:

P_{Powerclass}+ΔP_{IBE}−MAX(MAX(MPR_{f,c},A−MPR_{f,c})+ΔMB_{P,n},P−MPR_{f,c})−MAX{T(MAX(MPR_{f.c},A−MPR_{f,c})),T(P−MPR_{f,c})}≤P_{UMAX,f,c}≤EIRPₘₐₓ

while the corresponding measured total radiated power P_{TMAX,f,c} is bound by:

P_{RMAX,f,c}≤TRPₘₐₓ

The EIRPₘₐₓ generally designates the applicable maximum EIRP. The power class in FR2 may include UE power class 1 for fixed wireless access (FWA) UE, power class 2 for vehicular UE, power class 3 for handheld UE, and power class 4 for high power non-handheld UE. For power class 3, example maximum TRP (in dBm) maximum output power limits for operating bands n257, n258, n259, n260, and n261 may be configured as 23 dBm with the corresponding maximum EIRP values (in dBm) may be configured as 43 dBm.

However, advanced wireless communication systems/UE may permit scheduling UE 205 to perform multiple uplink transmissions (e.g., some of which may partially or fully overlap in the time domain). However, conventional techniques may not provide a mechanism for the UE to select the transmission power for each uplink transmission in the situation where UE 205 is performing multiple uplink transmissions at the same time.

For example, such conventional techniques do not provide, for simultaneous uplink transmissions in a given CC (e.g., in a given uplink carrier and/or uplink serving cell), a mechanism for UE 205 to select or otherwise determine P_{Cmax,f,c}, and the like. The simultaneous uplink transmission in this example may be within a given PUSCH (e.g., different layers transmitted from different UE panels in a SDM PUSCH scheme) and/or across two channels (e.g., PUSCH+PUSCH, PUCCH+PUCCH, PUSCH+PUCCH, and the like). Such conventional techniques do not provide a power class for such a plurality of time-domain overlapping (e.g., simultaneous) uplink transmissions, whether the total power is the same (e.g., as discussed above) or is increased, whether a limit (e.g., maximum transmission power) for the uplink transmissions is defined, and the like.

Accordingly, aspects of the techniques described herein provide various mechanisms to support simultaneous uplink transmissions 210 that improve uplink throughput and reliability, support such uplink transmissions 210 occurring in FR2 and across multiple TRPs, and the like. Such techniques may be applicable across existing UE power classes and/or may define a new power class for UE performing simultaneous uplink transmissions 210. Generally, such techniques may be applicable for the simultaneous uplink transmissions 210 occurring for a given CC.

It is to be understood that uplink transmissions 210 occurring simultaneously may be based on various factors on a per-uplink transmission basis. In some examples, each uplink transmission 210 may be associated with a UE panel k (e.g., uplink transmission 210-a may be associated with a first UE panel and uplink transmission 210-b may be associated with a second UE panel). The value k may generally refer to a given uplink transmission 210, such as a particular UE panel in this example. A UE panel may generally refer to any antenna, antenna set, panel of antennas, a portion of a panel of antennas, an antenna configuration, a transmit chain, a transmit chain-antenna pair, and the like, of UE 205.

In some examples, each uplink transmission 210 may be associated with a particular CORESET or a particular group of CORESETs. For example, UE 205 may be configured with multiple CORESETs, where each CORESET belongs to one group (one CORESET pool index value), and uplink transmission 210 is associated to one group (one CORESET pool index value). Accordingly, a CORESET pool index value (CORESETPoolIndex) k may correspond to a given uplink transmission 210.

In some examples, each uplink transmission 210 may be associated with a given TRP. For example, network entity 215 and/or network entity 220 may be examples of different TRPs receiving an uplink transmission 210 from UE 205. In this context, uplink transmission 210-a may correspond to the uplink transmission to network entity 215 and the uplink transmission 210-b may correspond to the uplink transmission to network entity 220.

In some examples, each uplink transmission 210 may be associated with a given beam or group of beams. For example, the plurality of time-domain overlapping uplink transmissions (e.g., uplink transmissions 210) may be SDM such that UE 205 uses a first beam/beam group for performing uplink transmission 210-a to network entity 215 and uses a second beam/beam group for performing uplink transmission 210-b to network entity 220.

Accordingly, references to a specific uplink transmission 210 in the plurality of time-domain overlapping uplink transmissions by UE 205 may be for a given UE panel k, for a CORESET pool index value k, for a TRP k, for a given cell, and/or for a beam/beam group k. Although FIG. 2 illustrates an example where the numerical quantity of the uplink transmissions 210 is two, it is to be understood that there may be more than two simultaneous uplink transmissions 210 that overlap, at least to some degree, in the time-domain.

UE 205 may receive or otherwise obtain a control message (e.g., in the case of single DCI-based multi-TRP scheduling) that schedules a plurality of time-domain uplink transmissions (e.g., uplink transmission 210-a and uplink transmission 210-b, in this example). In some examples, the control message may include an uplink grant configuring UE 205 to perform the uplink transmissions 210, such as a DCI format 0_0/0_1 grant. In other examples, UE 205 may receive or otherwise obtain multiple control messages (e.g., in the case of multi-DCI based multi-TRP scheduling) that schedule a plurality of time-domain uplink transmissions. In other examples, the uplink transmissions 210 may be performed using semi-persistent resources (e.g., configured grant (CG) resources). In this example, the control message may include RRC and/or MAC CE configuration signaling that configures the CG resources and the corresponding MAC CE and/or DCI trigger of the CG resources for performing the uplink transmissions 210. Accordingly, UE 205 may select, identify, or otherwise determine the resources and/or configuration for the uplink transmissions 210 based on the control message.

UE 205 may identify, select, or otherwise determine a transmission power for each uplink transmission 210. Broadly, this may include UE 205 scaling the maximum transmission power and/or scaling the actual transmission power for each uplink transmission 210. In some aspects, such scaling may be based on how many (e.g., the numerical quantity, which is two in this example) uplink transmissions 210 are scheduled in an overlapping time-domain manner. As discussed above, the uplink transmission 210 may be scheduled on an uplink carrier (e.g., an uplink CC) of UE 205.

In a first example, this may include the UE maximum output power limit being unchanged for the CC. There may be no need to change the power class of UE 205. Instead, when UE 205 is configured with simultaneous uplink transmissions in a given CC, UE 205 may select its maximum output power (e.g., P_{Cmax,f,c}) for carrier f of serving cell c, such as discussed above. However, in this example UE 205 may select its maximum output power defined for carrier f of serving cell c and for UE panel k, or associated with CORESET pool index value k, or TRP k, or beam/beam group k (e.g., on a per-uplink transmission 210 basis and using P_{Cmax,f,c,k}). This may result in UE 205 selecting its maximum output powers such that P_{Cmax,f,c,0}+P_{Cmax,f,c,1}=P_{Cmax,f,c}, where P_{Cmax,f,c,0} corresponds to the maximum output transmission power for a first uplink transmission 210 (e.g., uplink transmission 210-a) and P_{Cmax,f,c,1} corresponds to the maximum output transmission power for a second uplink transmission 210 (e.g., uplink transmission 210-b).

This may include UE 205 scaling the actual transmission power for each uplink transmission 210 based on the number of uplink transmissions 210. That is, UE 205 may identify or otherwise determine the maximum available transmission power (e.g., P_{Cmax,f,c}) for the uplink CC and then cap the transmission power for each uplink transmission. For example, UE 205 may cap, reduce, or otherwise modify the transmission power of each uplink transmission 210 to limit the sum of the actual transmission power for each uplink transmission 210 within the maximum available transmission power (e.g., P_{Cmax,f,c}). Accordingly, UE 205 may select its maximum output power P_{Cmax,f,c,k} for K=0,1 (in this example) based on the UE selected maximum output power P_{Cmax,f,c}.

In some aspects, this may include UE 205 equally dividing the maximum available transmission power among each uplink transmission 210. For example, UE may divide the maximum output transmission power for the CC by the number of uplink transmissions 210 in the linear domain (e.g., P_{Cmax,f,c,k}=P_{Cmax,f,c}/2 for k=0,1, or by 3 for k=0,1,2, and so on.

In some aspects, a weighting factor may be applied to each uplink transmission 210 such that the weighting factor (e.g., alpha) determines the maximum output transmission power (e.g., P_{Cmax,f,c,k}) for the uplink transmission 210. Accordingly, UE 205 may cap the actual transmission power for each uplink transmission 210 according to the weighting factor. For example and again in the linear domain, UE 205 may determine P_{Cmax,f,c,0}=alpha. P_{Cmax,f,c} and P_{Cmax,f,c,1}=(1−alpha)·P_{Cmax,f,c}, again in the example where there are two uplink transmissions 210. The weighting factor (e.g., alpha) may generally be based on the capability of UE 205 (e.g., as indicated in a UE capability message and/or information assistance request message), RRC configured, and the like.

Accordingly, in this first example UE 205 may cap, limit, or otherwise modify the uplink transmission power for an uplink transmission 210 as P_{Cmax,f,c,k}. In some examples, such capping may be conditioned on the simultaneous uplink transmissions 210 actually occurring in a set of symbols associated with different indices k (e.g., for shared power across multiple UE panels k). That is, capping the actual transmission power may be based on the overlap between the uplink transmissions in the time domain.

In other examples, such capping may be independent of the simultaneous uplink transmissions 210 actually occurring in a set of symbols (e.g., so long as the simultaneous uplink transmissions 210 are semi-statically configured), such as for separate power limits across multiple UE panels k. Accordingly, in this example capping the actual transmission power is independent of the overlap between the uplink transmissions 210 in the time domain. In some aspects of this example, if an uplink transmission 210 is not associated with an index k (e.g., SRS/PRACH may not be associated with a UE panel/TRP explicitly), a default index of k=0 may be assumed and the UE selected maximum output transmission power of P_{Cmax,f,c,0} is applied.

In some aspects, UE 205 may receive or otherwise obtain a signal configuring the maximum allowed transmission power for each uplink transmission 210. For example, the maximum transmit power allowed in a serving cell may be RRC configured separately for each UE panel k (e.g., two p-MAX values can be RRC configured to determine P_{EMAX,c,0} and P_{EMAX,c.1}) that are then used by UE 205 to select the maximum available transmission power (e.g., P_{Cmax,f,c,0} and P_{Cmax,f,c,1}). In some aspects, such per-UE panel transmission power configuration may be applicable when the uplink transmissions 210 are performed in FR1, although may be equally applicable to other frequency ranges.

In some examples of this first option, UE 205 may identify or otherwise determine that the sum of the actual transmission power for each uplink transmission 210 fails to satisfy the maximum available transmission power (e.g., P_{Cmax,f,c}) for the uplink CC (e.g., the sum of the transmission power for uplink transmission 210-a and uplink transmission 210-b is greater than P_{Cmax,f,c}). In this situation, UE 205 may adapt the uplink transmissions 210 to satisfy the maximum available transmission power. One option may include UE 205 canceling one or more of the uplink transmissions 210. For example, UE 205 may drop the uplink transmission 210 associated with one of the transmissions, such as the uplink transmission 210 associated with the second UE panel/CORESET pool index value 1 (e.g., P_{Cmax,f,c,1}). Another option may include UE 205 scaling down the actual transmission power for each uplink transmission 210. For example, the transmission power of both (e.g., all) uplink transmissions 210 may be reduced by a factor such that the sum of the actual transmission power from all uplink transmissions 210 becomes equal to or smaller than P_{Cmax,f,c}. A third option may include UE 205 scaling down the actual transmission power for one or more of the uplink transmissions 210. For example, the actual transmission power of the second uplink transmission 210 (e.g., the uplink transmission 210 associated with the second UE panel/CORESET pool index value 1) may be reduced by a factor such that the sum of the actual transmission power from all uplink transmissions 210 become equal to or smaller than P_{Cmax,f,c}. This may include UE 205 calculating the transmission power for the first uplink transmission 210 as P_{ULchannel,f,c,0} considering P_{Cmax,f,c} and then calculating the transmission power for the second uplink transmission 210 as P_{ULchannel,f,c,1} considering the cap P_{Cmax,f,c}−P_{ULchannel,f,c,0} (e.g., minus the linear domain and then converting to dBm).

In a second option, the UE maximum output power limit may be increased (e.g., scaled) for the plurality of uplink transmissions 210 that overlap in the time domain. For example, UE 205 may scale the transmission power for each uplink transmission 210 according to a maximum available transmission power for each uplink transmission 210. That is, when UE 205 is configured with simultaneous uplink transmissions 210 in a given CC, UE 205 may select its maximum output power P_{Cmax,f,c,k} for carrier f and serving cell c and UE panel k (or associated with CORESET pool index value k, or TRP k, or beam/beam group k). UE 205 may separately apply this to each uplink transmission 210 in the situation where multiple uplink transmissions (e.g., associated with different UE panels) are scheduled and overlap (at least to some degree) in the time domain.

In some aspects, this may include UE 205 identifying or otherwise determining the maximum available transmission power (e.g., P_{Cmax,f,c}) for each uplink transmission 210 and scaling up the maximum transmission power for each uplink transmission 210 to the maximum available transmission power. For example, the existing maximum output power limits for each power class may be applied per UE panel (e.g., P_{Cmax,f,c,k}=P_{Cmax,f,c}). In this example, the total transmission power across both UE panels is doubled.

In some aspects, this may include UE 205 identifying or otherwise determining the maximum available transmission power for each uplink transmission 210 based, at least to some degree, on a power class associated with time-domain overlapping uplink transmissions. Accordingly, UE 205 may scale the maximum transmission power for each uplink transmission 210 to the maximum available transmission power. For example, a new power class may be introduced that is specific to a UE scheduled with simultaneous uplink transmissions 210. In this situation, the per-UE panel maximum output power limits may be specified from which UE 205 may select P_{Cmax,f,c,k} separately. In some aspects, the maximum transmit power allowed in a serving cell may be RRC configured separately per-UE panel (e.g., two p-Max values can be RRC configured to determine P_{EMAX,c,0} and P_{EMAX,c,1} that are used by UE 205 to select the maximum available transmission powers P_{Cmax,f,c,0} and P_{Cmax,f,c,1} per uplink transmission 210). In some aspects, such configuration signaling may be applicable when the uplink transmissions 210 are scheduled in FR1, although may be equally applicable to other frequency ranges.

Accordingly, the techniques described herein provide various mechanisms for UE 205 to identify or otherwise determine the transmission power for each uplink transmission 210 when UE 205 is scheduled to perform a plurality of time-domain overlapping uplink transmission 210.

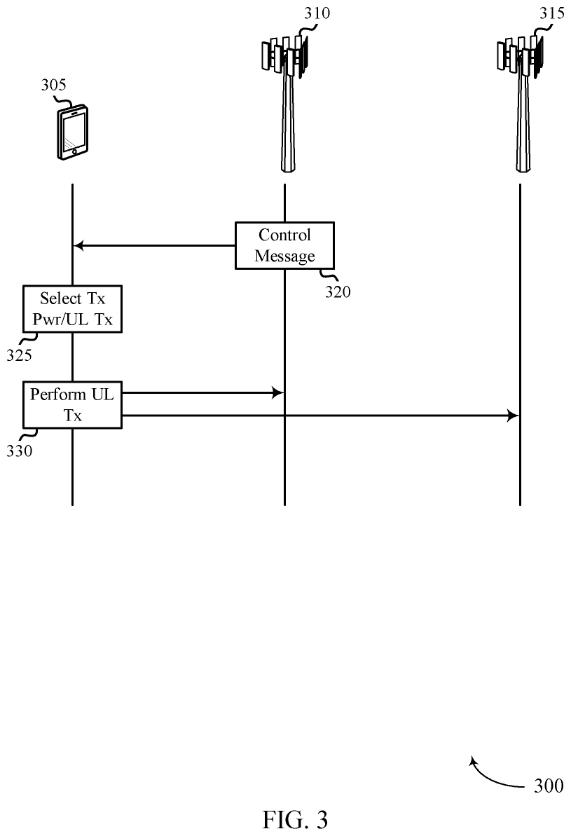

FIG. 3 illustrates an example of a process 300 that supports UE selected maximum output power for simultaneous transmissions in accordance with one or more aspects of the present disclosure. Aspects of process 300 may be implemented at or implemented at or implemented by UE 305, network entity 310, and/or network entity 315, which may be examples of the corresponding devices described herein.

At 320, network entity 310 may transmit or otherwise provide (and UE 305 may receive or otherwise obtain a control message. In some examples, the control message may schedule, identify, or otherwise convey an indication that UE 305 is to perform a plurality of transmissions. In some examples, some or all of the uplink transmissions may overlap, fully or partially, in the time-domain. In some examples, the plurality of time-domain overlapping uplink transmissions may be scheduled for an uplink CC of UE 305. In some aspects, the plurality of uplink transmissions may include any combination of PUSCH, PUCCH, SRS, and/or PRACH transmissions from UE 305.

In some examples, the control message may be a single message dynamically scheduling UE 305 to perform the plurality of uplink transmissions, such as a DCI grant. In some examples, the control message may include multiple messages scheduling the uplink transmissions for UE 305. For example, the control message may be a RRC and/or MAC CE message configuring resources (e.g., CG resources) and/or other parameters for the uplink transmissions as well as a MAC CE and/or DCI message that activates/triggers the uplink transmissions.

At 325, UE 305 may identify, select, or otherwise determine a transmission power for each uplink transmission. In some examples, this may include UE 305 scaling a maximum transmission power for each uplink transmission. In some examples, this may include UE 305 scaling an actual transmission power for each uplink transmission. In some examples, such scaling may be based on how many (e.g., the numerical quantity) uplink transmissions are scheduled for UE 305 on the CC.

In some examples, this may include UE 305 identifying a maximum available transmission power. For example, UE 305 may be configured for performing uplink transmissions on a given CC. The CC may be configured with a maximum available transmission power (e.g., P_{Cmax,f,c}). In this example, UE 305 may scale the transmission power of each uplink transmission. For example, UE 305 may cap, limit, reduce, or otherwise modify the transmission power. For example, UE 305 may cap the transmission power such that the sum of the actual transmission power of all of the uplink transmissions are within P_{Cmax,f,c,0}. In some examples, this may include UE 305 equally dividing the maximum available transmission power among each uplink transmission. In some examples, this may be based on a weighting factor. For example, each uplink transmission may be assigned or otherwise associated with a weighting factor. The weighting factor may be based on the index associated with each uplink transmission (e.g., k=0, k=1). The weighting factor may be based on a priority metric associated with each uplink transmission. The weighting factor may be based on a throughput requirement associated with each uplink transmission. The weighting factor may be associated with a latency requirement associated with each uplink transmission. The weighting factor may be configured for UE 305 (e.g., using RRC signaling) and/or may be autonomously selected or otherwise determined by UE 305. Accordingly, UE 305 may apply the weighting factor for each uplink transmission when allocating the maximum available transmission power.

In some examples, the sum of the actual transmission power may fail to satisfy the maximum available transmission power for the CC. In this situation, UE 305 may drop one or more of the uplink transmissions, may scale down the transmission power of each uplink transmission, and/or may scale down the transmission power for some of the uplink transmissions.

In some examples, the transmission power for each uplink transmission may be scaled to a maximum available transmission power for each uplink transmission (e.g., as opposed to the maximum available transmission power for the CC). The maximum available transmission power may be on a per-uplink transmission basis and/or a new power class may be adopted for UE performing multiple uplink transmissions that overlap in the time domain. The per-uplink transmission maximum available transmission power and/or power class may be configured for UE 305 and/or may be identified or selected autonomously by UE 305.

At 330, UE 305 may perform the uplink transmissions. For example, UE 305 may transmit a first uplink transmission to network entity 310 simultaneously while transmitting a second uplink transmission to network entity 315. The actual transmission power of each uplink transmission may be scaled (e.g., up or down) according to the techniques described herein.

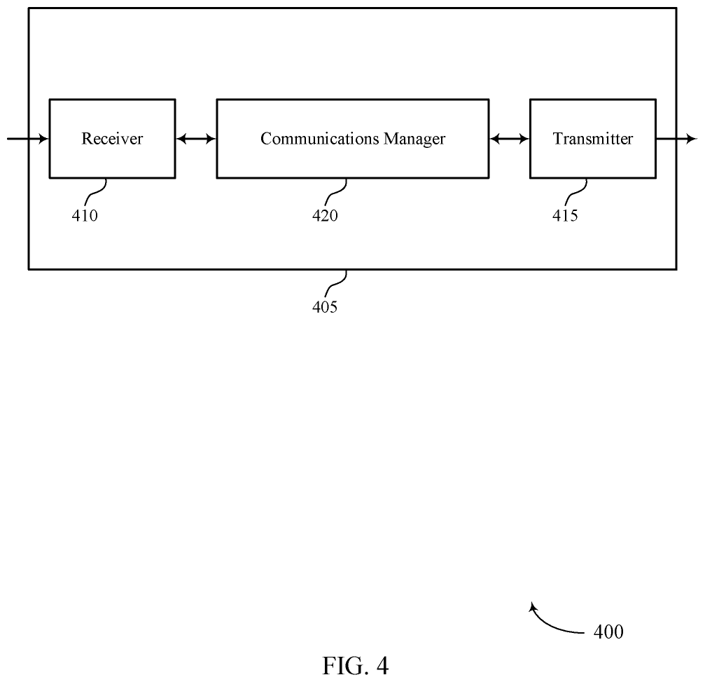

FIG. 4 shows a block diagram 400 of a device 405 that supports UE selected maximum output power for simultaneous transmissions in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to UE selected maximum output power for simultaneous transmissions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to UE selected maximum output power for simultaneous transmissions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of UE selected maximum output power for simultaneous transmissions as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving a control message scheduling a set of multiple time-domain overlapping uplink transmissions by the UE on an uplink component carrier. The communications manager 420 may be configured as or otherwise support a means for selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The communications manager 420 may be configured as or otherwise support a means for performing the set of multiple time-domain overlapping uplink transmissions on the uplink component carrier according to the selected transmission power for each uplink transmission.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for improved transmission power management/selection when a UE is scheduled to simultaneously perform multiple uplink transmissions.

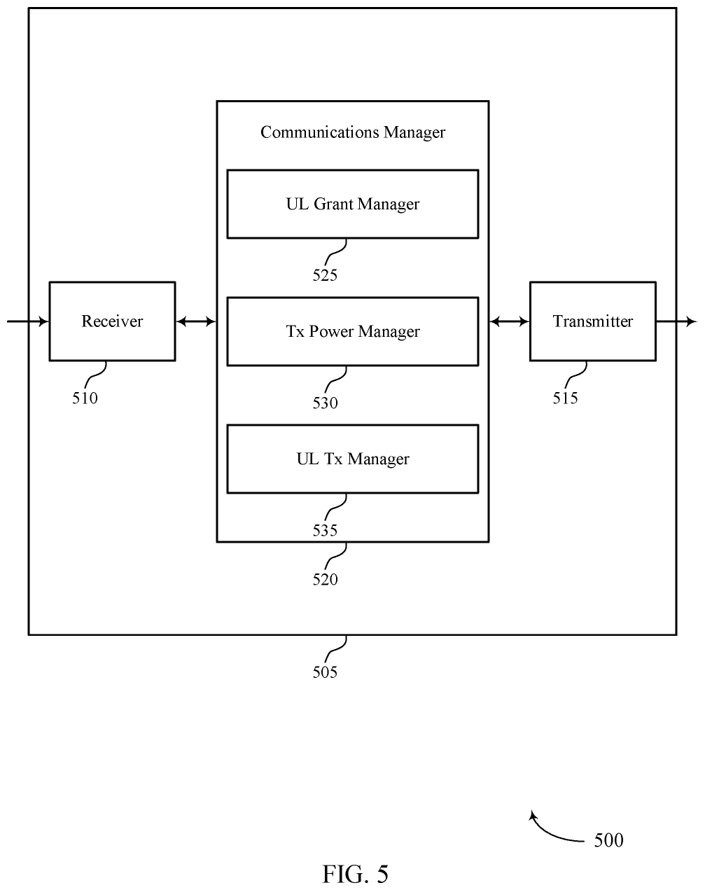

FIG. 5 shows a block diagram 500 of a device 505 that supports UE selected maximum output power for simultaneous transmissions in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to UE selected maximum output power for simultaneous transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE selected maximum output power for simultaneous transmissions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of UE selected maximum output power for simultaneous transmissions as described herein. For example, the communications manager 520 may include a UL grant manager 525, a Tx power manager 530, a UL Tx manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The UL grant manager 525 may be configured as or otherwise support a means for receiving a control message scheduling a set of multiple time-domain overlapping uplink transmissions by the UE on an uplink component carrier. The Tx power manager 530 may be configured as or otherwise support a means for selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The UL Tx manager 535 may be configured as or otherwise support a means for performing the set of multiple time-domain overlapping uplink transmissions on the uplink component carrier according to the selected transmission power for each uplink transmission.

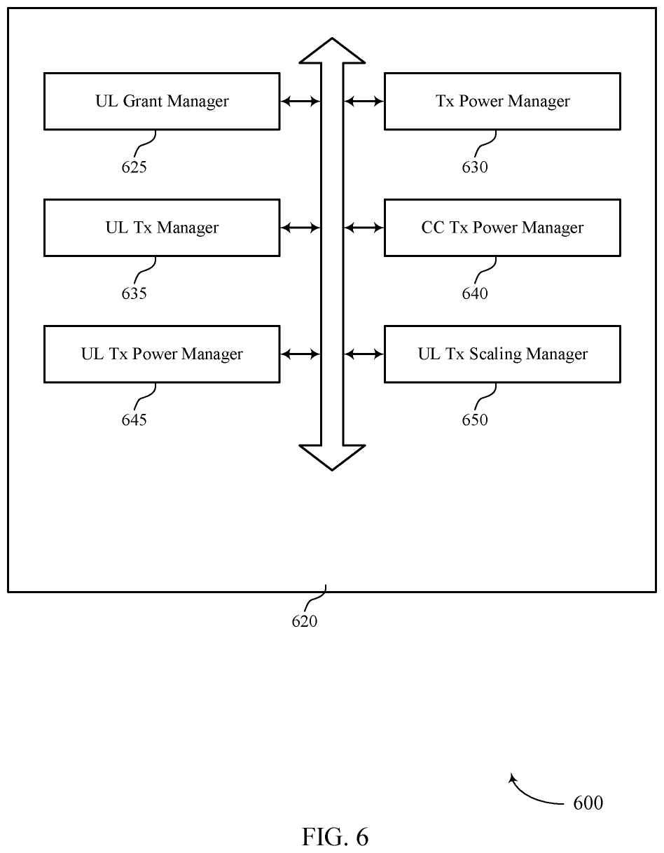

FIG. 6 shows a block diagram 600 of a communications manager 620 that supports UE selected maximum output power for simultaneous transmissions in accordance with one or more aspects of the present disclosure. The communications manager 620 may be an example of aspects of a communications manager 420, a communications manager 520, or both, as described herein. The communications manager 620, or various components thereof, may be an example of means for performing various aspects of UE selected maximum output power for simultaneous transmissions as described herein. For example, the communications manager 620 may include a UL grant manager 625, a Tx power manager 630, a UL Tx manager 635, a CC Tx power manager 640, a UL Tx power manager 645, a UL Tx scaling manager 650, or any combination thereof. Each of these components may communicate, directly or indirectly, with one another (e.g., via one or more buses).

The communications manager 620 may support wireless communication at a UE in accordance with examples as disclosed herein. The UL grant manager 625 may be configured as or otherwise support a means for receiving a control message scheduling a set of multiple time-domain overlapping uplink transmissions by the UE on an uplink component carrier. The Tx power manager 630 may be configured as or otherwise support a means for selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The UL Tx manager 635 may be configured as or otherwise support a means for performing the set of multiple time-domain overlapping uplink transmissions on the uplink component carrier according to the selected transmission power for each uplink transmission.

In some examples, to support selecting the transmission power for each uplink transmission in the set of multiple time-domain overlapping uplink transmissions, the CC Tx power manager 640 may be configured as or otherwise support a means for identifying a maximum available transmission power for the uplink component carrier. In some examples, to support selecting the transmission power for each uplink transmission in the set of multiple time-domain overlapping uplink transmissions, the CC Tx power manager 640 may be configured as or otherwise support a means for capping the transmission power for each uplink transmission to limit a sum of the actual transmission power for each uplink transmission within the maximum available transmission power.

In some examples, to support capping the actual transmission power, the CC Tx power manager 640 may be configured as or otherwise support a means for equally dividing the maximum available transmission power among each uplink transmission in the set of multiple time-domain overlapping uplink transmissions.

In some examples, to support capping the actual transmission power, the CC Tx power manager 640 may be configured as or otherwise support a means for assigning a weighting factor to each uplink transmission. In some examples, to support capping the actual transmission power, the CC Tx power manager 640 may be configured as or otherwise support a means for capping the actual transmission power for each uplink transmission according to the assigned weighting factor. In some examples, capping the actual transmission power is based on an overlap between the uplink transmissions in a time domain. In some examples, capping the actual transmission power is independent from an overlap between the uplink transmissions in a time domain.

In some examples, the UL Tx power manager 645 may be configured as or otherwise support a means for receiving a signal configuring a maximum available transmission power for each uplink transmission.

In some examples, the UL Tx manager 635 may be configured as or otherwise support a means for cancelling one or more of the uplink transmissions based on a sum of the actual transmission power for each uplink transmission failing to satisfy a maximum available transmission power for the uplink component carrier.

In some examples, the UL Tx scaling manager 650 may be configured as or otherwise support a means for scaling down the actual transmission power of each uplink transmission based on a sum of the actual transmission power for each uplink transmission failing to satisfy a maximum available transmission power for uplink component carrier. In some examples, the UL Tx scaling manager 650 may be configured as or otherwise support a means for scaling down the actual transmission power of one or more of the uplink transmissions based on a sum of the actual transmission power for each uplink transmission failing to satisfy a maximum available transmission power for the uplink component carrier.

In some examples, the UL Tx scaling manager 650 may be configured as or otherwise support a means for scaling the transmission power for each uplink transmission according to a maximum available transmission power for each uplink transmission. In some examples, the UL Tx scaling manager 650 may be configured as or otherwise support a means for identifying the maximum available transmission power for each uplink transmission. In some examples, the UL Tx scaling manager 650 may be configured as or otherwise support a means for scaling up the maximum transmission power for each uplink transmission to the maximum available transmission power.

In some examples, the UL Tx scaling manager 650 may be configured as or otherwise support a means for identifying the maximum available transmission power for each uplink transmission based on a power class associated with time-domain overlapping uplink transmissions. In some examples, the UL Tx scaling manager 650 may be configured as or otherwise support a means for scaling the maximum transmission power for each uplink transmission to the maximum available transmission power.

In some examples, the UL Tx scaling manager 650 may be configured as or otherwise support a means for receiving a signal configuring the maximum available transmission power for each uplink transmission based on the power class. In some examples, each uplink transmission in the set of multiple time-domain overlapping uplink transmissions is associated with at least one of an antenna panel configuration of the UE, a control resource set pool index value of the UE, a node receiving the uplink transmission, a beam being used for the uplink transmission, or any combination thereof.

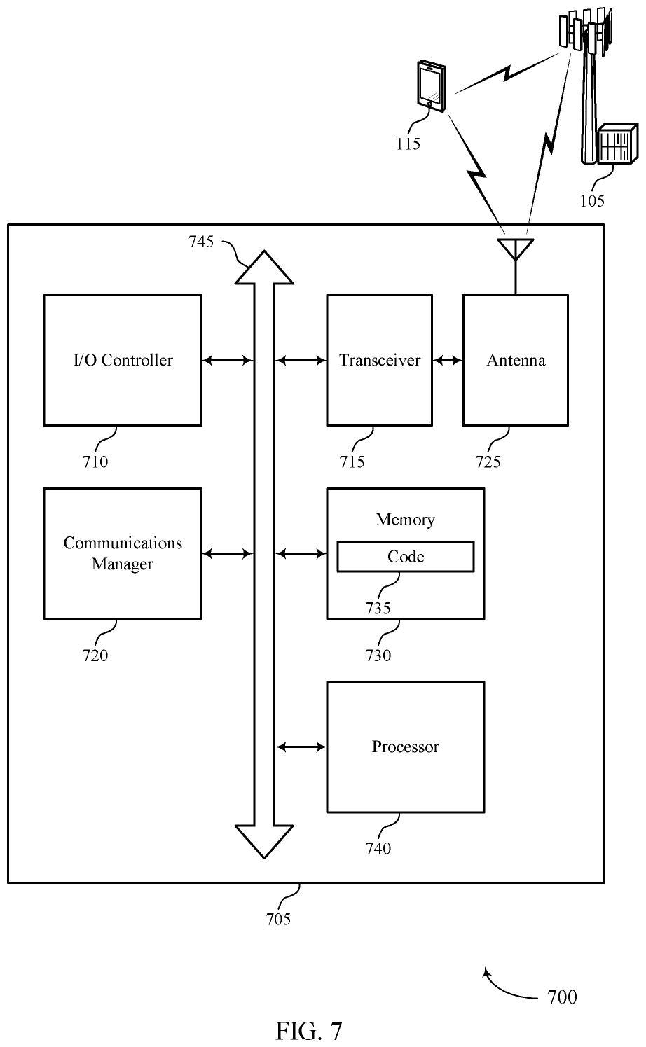

FIG. 7 shows a diagram of a system 700 including a device 705 that supports UE selected maximum output power for simultaneous transmissions in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting UE selected maximum output power for simultaneous transmissions). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a control message scheduling a set of multiple time-domain overlapping uplink transmissions by the UE on an uplink component carrier. The communications manager 720 may be configured as or otherwise support a means for selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The communications manager 720 may be configured as or otherwise support a means for performing the set of multiple time-domain overlapping uplink transmissions on the uplink component carrier according to the selected transmission power for each uplink transmission.

By including or configuring the communications manager 720 in accordance with examples as described herein, the device 705 may support techniques for improved transmission power management/selection when a UE is scheduled to simultaneously perform multiple uplink transmissions.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of UE selected maximum output power for simultaneous transmissions as described herein, or the processor 740 and the memory 730 may be otherwise configured to perform or support such operations.

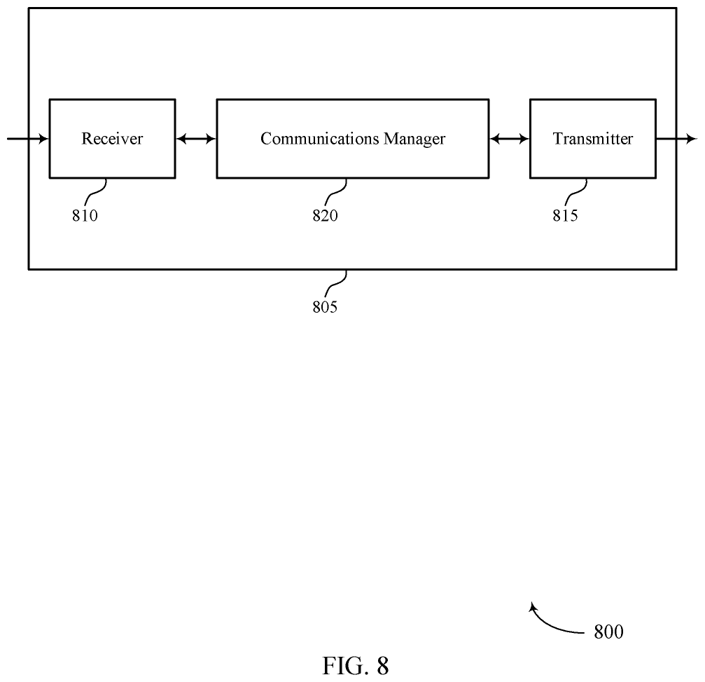

FIG. 8 shows a block diagram 800 of a device 805 that supports UE selected maximum output power for simultaneous transmissions in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of UE selected maximum output power for simultaneous transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The communications manager 820 may be configured as or otherwise support a means for receiving one or more uplink transmissions of the set of multiple time-domain overlapping uplink transmissions on the uplink component carrier according to the selected transmission power for each uplink transmission.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for improved transmission power management/selection when a UE is scheduled to simultaneously perform multiple uplink transmissions.

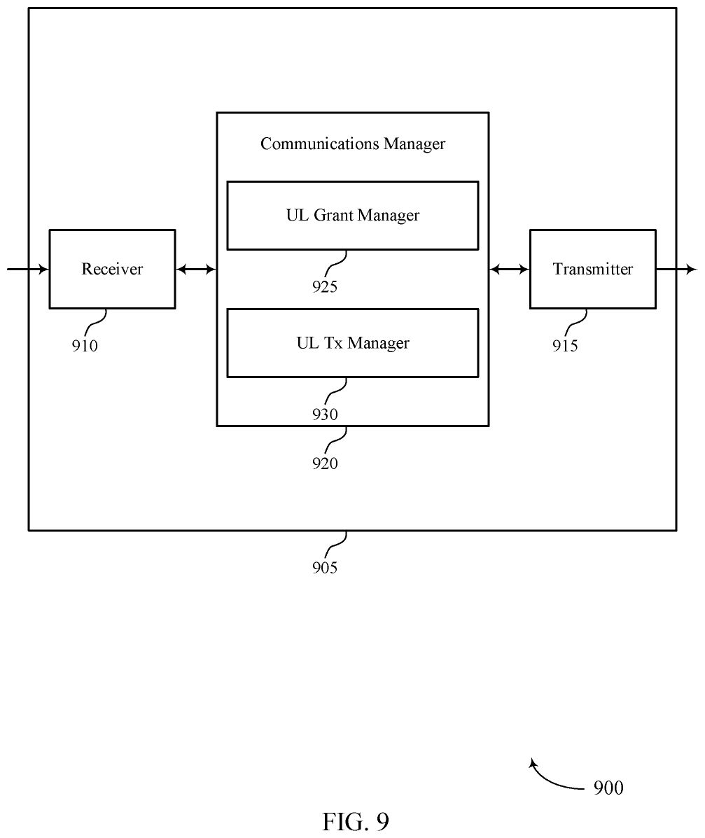

FIG. 9 shows a block diagram 900 of a device 905 that supports UE selected maximum output power for simultaneous transmissions in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of UE selected maximum output power for simultaneous transmissions as described herein. For example, the communications manager 920 may include a UL grant manager 925 a UL Tx manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The UL grant manager 925 may be configured as or otherwise support a means for transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The UL Tx manager 930 may be configured as or otherwise support a means for receiving one or more uplink transmissions of the set of multiple time-domain overlapping uplink transmissions on the uplink component carrier according to the selected transmission power for each uplink transmission.

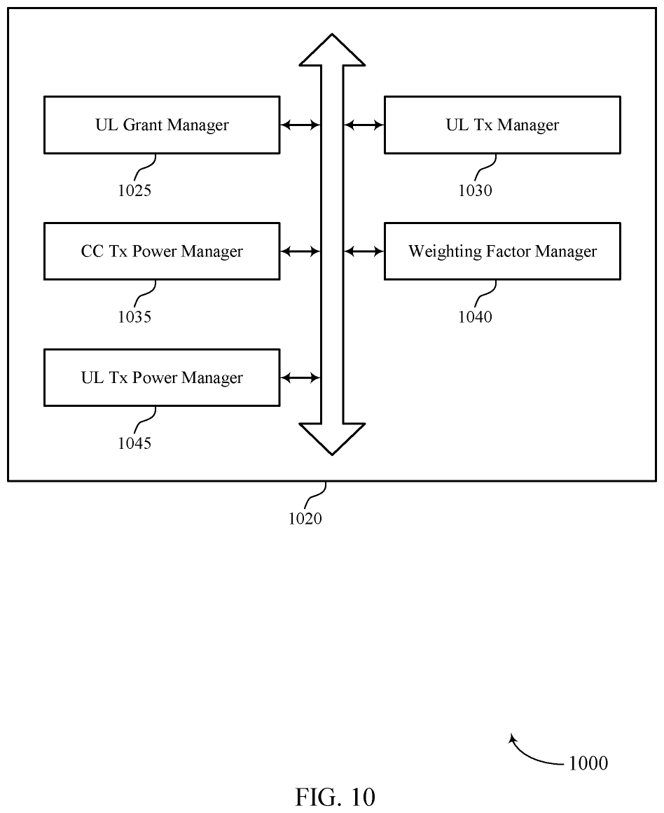

FIG. 10 shows a block diagram 1000 of a communications manager 1020 that supports UE selected maximum output power for simultaneous transmissions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of UE selected maximum output power for simultaneous transmissions as described herein. For example, the communications manager 1020 may include a UL grant manager 1025, a UL Tx manager 1030, a CC Tx power manager 1035, a weighting factor manager 1040, a UL Tx power manager 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The UL grant manager 1025 may be configured as or otherwise support a means for transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The UL Tx manager 1030 may be configured as or otherwise support a means for receiving one or more uplink transmissions of the set of multiple time-domain overlapping uplink transmissions on the uplink component carrier according to the selected transmission power for each uplink transmission.

In some examples, the CC Tx power manager 1035 may be configured as or otherwise support a means for transmitting a signal identifying a maximum allowed transmission power for the uplink component carrier, where the selected transmission power for each uplink transmission is based on the maximum allowed transmission power.

In some examples, the weighting factor manager 1040 may be configured as or otherwise support a means for transmitting a signal identifying a weighting factor for each uplink transmission.

In some examples, the UL Tx power manager 1045 may be configured as or otherwise support a means for transmitting a signal identifying a maximum allowed transmission power each uplink transmission, where the selected transmission power for each uplink transmission is based on the maximum allowed transmission power.

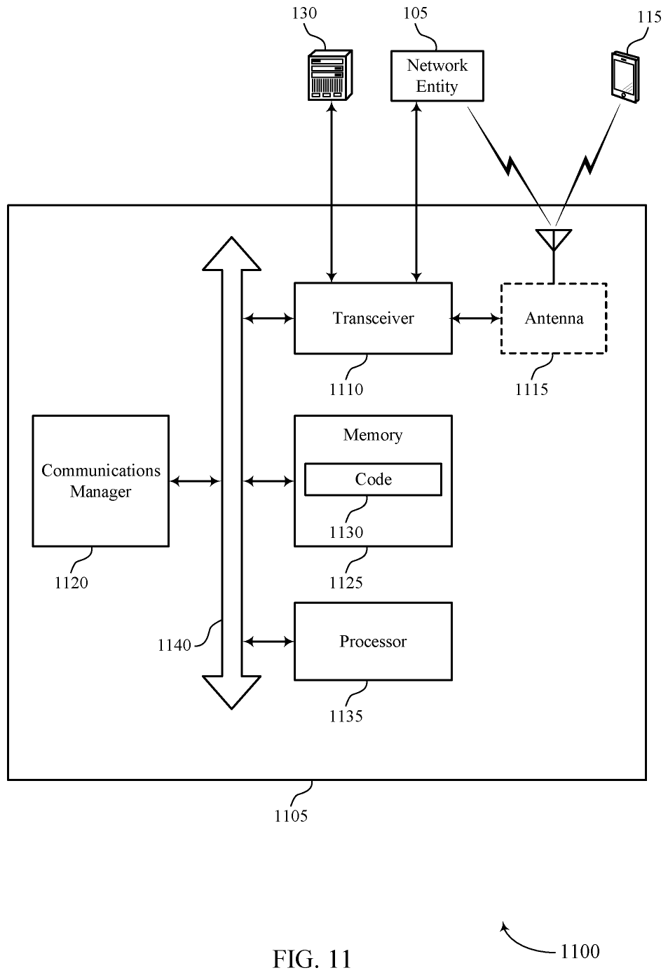

FIG. 11 shows a diagram of a system 1100 including a device 1105 that supports UE selected maximum output power for simultaneous transmissions in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting UE selected maximum output power for simultaneous transmissions). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The communications manager 1120 may be configured as or otherwise support a means for receiving one or more uplink transmissions of the set of multiple time-domain overlapping uplink transmissions on the uplink component carrier according to the selected transmission power for each uplink transmission.

By including or configuring the communications manager 1120 in accordance with examples as described herein, the device 1105 may support techniques for improved transmission power management/selection when a UE is scheduled to simultaneously perform multiple uplink transmissions.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of UE selected maximum output power for simultaneous transmissions as described herein, or the processor 1135 and the memory 1125 may be otherwise configured to perform or support such operations.

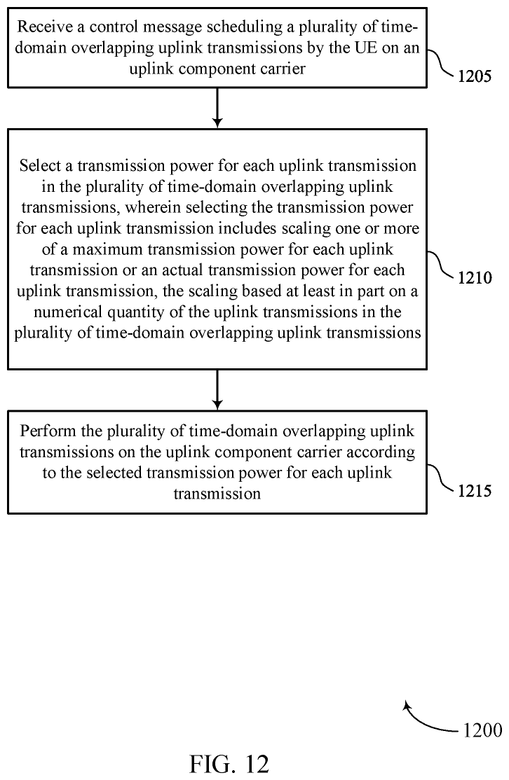

FIG. 12 shows a flowchart illustrating a method 1200 that supports UE selected maximum output power for simultaneous transmissions in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message scheduling a set of multiple time-domain overlapping uplink transmissions by the UE on an uplink component carrier. The operations of 1205 may be performed in accordance with examples as disclosed herein. In some examples, aspects of the operations of 1205 may be performed by a UL grant manager 625 as described with reference to FIG. 6.

At 1210, the method may include selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The operations of 1210 may be performed in accordance with examples as disclosed herein. In some examples, aspects of the operations of 1210 may be performed by a Tx power manager 630 as described with reference to FIG. 6.

At 1215, the method may include performing the set of multiple time-domain overlapping uplink transmissions on the uplink component carrier according to the selected transmission power for each uplink transmission. The operations of 1215 may be performed in accordance with examples as disclosed herein. In some examples, aspects of the operations of 1215 may be performed by a UL Tx manager 635 as described with reference to FIG. 6.

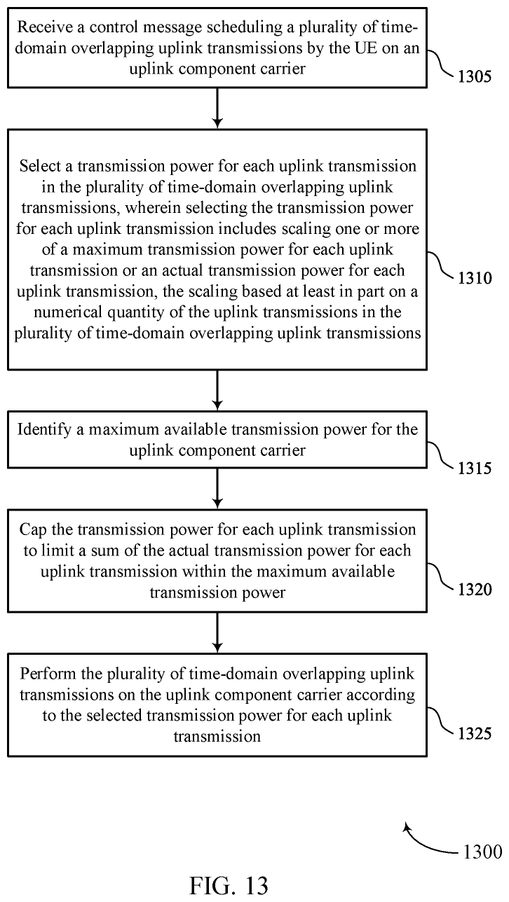

FIG. 13 shows a flowchart illustrating a method 1300 that supports UE selected maximum output power for simultaneous transmissions in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message scheduling a set of multiple time-domain overlapping uplink transmissions by the UE on an uplink component carrier. The operations of 1305 may be performed in accordance with examples as disclosed herein. In some examples, aspects of the operations of 1305 may be performed by a UL grant manager 625 as described with reference to FIG. 6.

At 1310, the method may include selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The operations of 1310 may be performed in accordance with examples as disclosed herein. In some examples, aspects of the operations of 1310 may be performed by a Tx power manager 630 as described with reference to FIG. 6.

At 1315, the method may include identifying a maximum available transmission power for the uplink component carrier. The operations of 1315 may be performed in accordance with examples as disclosed herein. In some examples, aspects of the operations of 1315 may be performed by a CC Tx power manager 640 as described with reference to FIG. 6.

At 1320, the method may include capping the transmission power for each uplink transmission to limit a sum of the actual transmission power for each uplink transmission within the maximum available transmission power. The operations of 1320 may be performed in accordance with examples as disclosed herein. In some examples, aspects of the operations of 1320 may be performed by a CC Tx power manager 640 as described with reference to FIG. 6.

At 1325, the method may include performing the set of multiple time-domain overlapping uplink transmissions on the uplink component carrier according to the selected transmission power for each uplink transmission. The operations of 1325 may be performed in accordance with examples as disclosed herein. In some examples, aspects of the operations of 1325 may be performed by a UL Tx manager 635 as described with reference to FIG. 6.

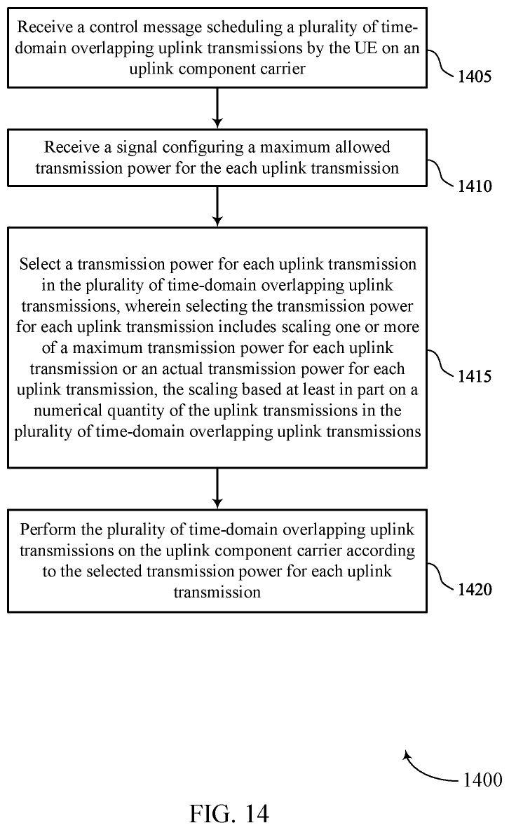

FIG. 14 shows a flowchart illustrating a method 1400 that supports UE selected maximum output power for simultaneous transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a control message scheduling a set of multiple time-domain overlapping uplink transmissions by the UE on an uplink component carrier. The operations of 1405 may be performed in accordance with examples as disclosed herein. In some examples, aspects of the operations of 1405 may be performed by a UL grant manager 625 as described with reference to FIG. 6.

At 1410, the method may include receiving a signal configuring a maximum available transmission power for each uplink transmission. The operations of 1410 may be performed in accordance with examples as disclosed herein. In some examples, aspects of the operations of 1410 may be performed by a UL Tx power manager 645 as described with reference to FIG. 6.

At 1415, the method may include selecting a transmission power for each uplink transmission in the set of multiple time-domain overlapping uplink transmissions, where selecting the transmission power for each uplink transmission includes scaling one or more of a maximum transmission power for each uplink transmission or an actual transmission power for each uplink transmission, the scaling based on a numerical quantity of the uplink transmissions in the set of multiple time-domain overlapping uplink transmissions. The operations of 1415 may be performed in accordance with examples as disclosed herein. In some examples, aspects of the operations of 1415 may be performed by a Tx power manager 630 as described with reference to FIG. 6.

At 1420, the method may include performing the set of multiple time-domain overlapping uplink transmissions on the uplink component carrier according to the selected transmission power for each uplink transmission. The operations of 1420 may be performed in accordance with examples as disclosed herein. In some examples, aspects of the operations of 1420 may be performed by a UL Tx manager 635 as described with reference to FIG. 6.

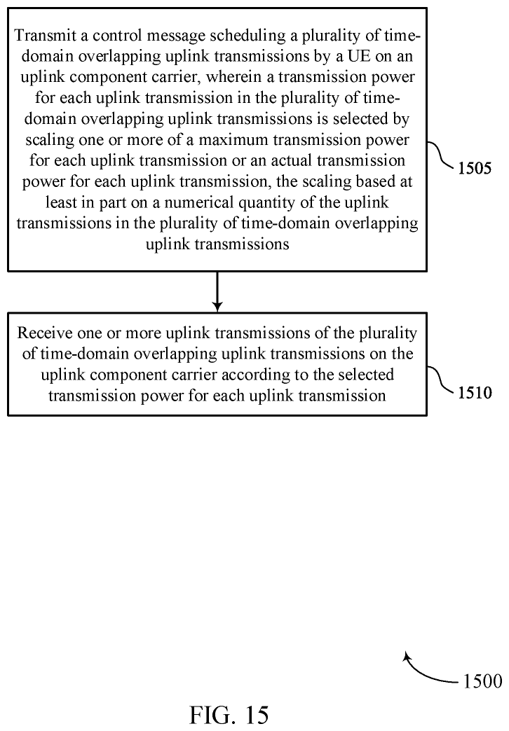

FIG. 15 shows a flowchart illustrating a method 1500 that supports UE selected maximum output power for simultaneous transmissions in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The operations of 1505 may be performed in accordance with examples as disclosed herein. In some examples, aspects of the operations of 1505 may be performed by a UL grant manager 1025 as described with reference to FIG. 10.

At 1510, the method may include receiving one or more uplink transmissions of the set of multiple time-domain overlapping uplink transmissions on the uplink component carrier according to the selected transmission power for each uplink transmission. The operations of 1510 may be performed in accordance with examples as disclosed herein. In some examples, aspects of the operations of 1510 may be performed by a UL Tx manager 1030 as described with reference to FIG. 10.

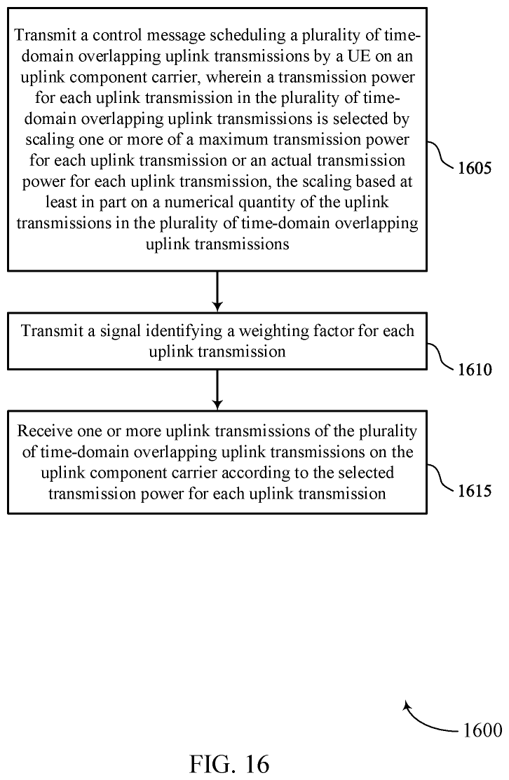

FIG. 16 shows a flowchart illustrating a method 1600 that supports UE selected maximum output power for simultaneous transmissions in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message scheduling a set of multiple time-domain overlapping uplink transmissions by a UE on an uplink component carrier, where a transmission power for each uplink transmission in the set of multiple time-domain overlapping uplink transmissions is selected by scaling one or more of a maximum transmission power for each uplink transmission or an actual transmission power for each uplink transmission, the scaling based on a numerical quantity of the uplink transmissions in the set of multiple time-domain overlapping uplink transmissions. The operations of 1605 may be performed in accordance with examples as disclosed herein. In some examples, aspects of the operations of 1605 may be performed by a UL grant manager 1025 as described with reference to FIG. 10.

At 1610, the method may include transmitting a signal identifying a weighting factor for each uplink transmission. The operations of 1610 may be performed in accordance with examples as disclosed herein. In some examples, aspects of the operations of 1610 may be performed by a weighting factor manager 1040 as described with reference to FIG. 10.

At 1615, the method may include receiving one or more uplink transmissions of the set of multiple time-domain overlapping uplink transmissions on the uplink component carrier according to the selected transmission power for each uplink transmission. The operations of 1615 may be performed in accordance with examples as disclosed herein. In some examples, aspects of the operations of 1615 may be performed by a UL Tx manager 1030 as described with reference to FIG. 10.

The following provides an overview of aspects of the present disclosure:
Aspect 1: A method for wireless communication at a UE, comprising: receiving a control message scheduling a plurality of time-domain overlapping uplink transmissions by the UE on an uplink component carrier; selecting a transmission power for each uplink transmission in the plurality of time-domain overlapping uplink transmissions, wherein selecting the transmission power for each uplink transmission includes scaling one or more of a maximum transmission power for each uplink transmission or an actual transmission power for each uplink transmission, the scaling based at least in part on a numerical quantity of the uplink transmissions in the plurality of time-domain overlapping uplink transmissions; and performing the plurality of time-domain overlapping uplink transmissions on the uplink component carrier according to the selected transmission power for each uplink transmission.
Aspect 2: The method of aspect 1, wherein selecting the transmission power for each uplink transmission in the plurality of time-domain overlapping uplink transmissions comprises: identifying a maximum available transmission power for the uplink component carrier; and capping the transmission power for each uplink transmission to limit a sum of the actual transmission power for each uplink transmission within the maximum available transmission power.
Aspect 3: The method of aspect 2, wherein capping the actual transmission power comprises: equally dividing the maximum available transmission power among each uplink transmission in the plurality of time-domain overlapping uplink transmissions.
Aspect 4: The method of any of aspects 2 through 3, wherein capping the actual transmission power comprises: assigning a weighting factor to each uplink transmission; and capping the actual transmission power for each uplink transmission according to the assigned weighting factor.
Aspect 5: The method of aspect 4, wherein capping the actual transmission power is based at least in part on an overlap between the uplink transmissions in a time domain.
Aspect 6: The method of any of aspects 4 through 5, wherein capping the actual transmission power is independent from an overlap between the uplink transmissions in a time domain.
Aspect 7: The method of any of aspects 1 through 6, further comprising: receiving a signal configuring a maximum allowable transmission power for the each uplink transmission.
Aspect 8: The method of any of aspects 1 through 7, further comprising: cancelling one or more of the uplink transmissions based at least in part on a sum of the actual transmission power for each uplink transmission failing to satisfy a maximum available transmission power for the uplink component carrier.
Aspect 9: The method of any of aspects 1 through 8, further comprising: scaling down the actual transmission power of each uplink transmission based at least in part on a sum of the actual transmission power for each uplink transmission failing to satisfy a maximum available transmission power for uplink component carrier.
Aspect 10: The method of any of aspects 1 through 9, further comprising: scaling down the actual transmission power of one or more of the uplink transmissions based at least in part on a sum of the actual transmission power for each uplink transmission failing to satisfy a maximum available transmission power for the uplink component carrier.
Aspect 11: The method of any of aspects 1 through 10, further comprising: scaling the transmission power for each uplink transmission according to a maximum available transmission power for each uplink transmission.
Aspect 12: The method of aspect 11, further comprising: identifying the maximum available transmission power for each uplink transmission; and scaling up the maximum transmission power for each uplink transmission to the maximum available transmission power.
Aspect 13: The method of any of aspects 11 through 12, further comprising: identifying the maximum available transmission power for each uplink transmission based at least in part on a power class associated with time-domain overlapping uplink transmissions; and scaling the maximum transmission power for each uplink transmission to the maximum available transmission power.
Aspect 14: The method of aspect 13, further comprising: receiving a signal configuring the maximum allowable transmission power for each uplink transmission based at least in part on the power class.
Aspect 15: The method of any of aspects 1 through 14, wherein each uplink transmission in the plurality of time-domain overlapping uplink transmissions is associated with at least one of an antenna panel configuration of the UE, a control resource set pool index value of the UE, a node receiving the uplink transmission, a beam being used for the uplink transmission, or any combination thereof.
Aspect 16: A method for wireless communication at a network entity, comprising: transmitting a control message scheduling a plurality of time-domain overlapping uplink transmissions by a UE on an uplink component carrier, wherein a transmission power for each uplink transmission in the plurality of time-domain overlapping uplink transmissions is selected by scaling one or more of a maximum transmission power for each uplink transmission or an actual transmission power for each uplink transmission, the scaling based at least in part on a numerical quantity of the uplink transmissions in the plurality of time-domain overlapping uplink transmissions; and receiving one or more uplink transmissions of the plurality of time-domain overlapping uplink transmissions on the uplink component carrier according to the selected transmission power for each uplink transmission.
Aspect 17: The method of aspect 16, further comprising: transmitting a signal identifying a maximum available transmission power for the uplink component carrier, wherein the selected transmission power for each uplink transmission is based at least in part on the maximum available transmission power.
Aspect 18: The method of any of aspects 16 through 17, further comprising: transmitting a signal identifying a weighting factor for each uplink transmission.
Aspect 19: The method of any of aspects 16 through 18, further comprising: transmitting a signal identifying a maximum available transmission power each uplink transmission, wherein the selected transmission power for each uplink transmission is based at least in part on the maximum available transmission power.
Aspect 20: An apparatus for wireless communication at a UE, comprising a processor; memory coupled with the processor; and instructions stored in the memory and executable by the processor to cause the apparatus to perform a method of any of aspects 1 through 15.
Aspect 21: An apparatus for wireless communication at a UE, comprising at least one means for performing a method of any of aspects 1 through 15.
Aspect 22: A non-transitory computer-readable medium storing code for wireless communication at a UE, the code comprising instructions executable by a processor to perform a method of any of aspects 1 through 15.
Aspect 23: An apparatus for wireless communication at a network entity, comprising a processor; memory coupled with the processor; and instructions stored in the memory and executable by the processor to cause the apparatus to perform a method of any of aspects 16 through 19.
Aspect 24: An apparatus for wireless communication at a network entity, comprising at least one means for performing a method of any of aspects 16 through 19.
Aspect 25: A non-transitory computer-readable medium storing code for wireless communication at a network entity, the code comprising instructions executable by a processor to perform a method of any of aspects 16 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a control message scheduling a plurality of time-domain overlapping uplink transmissions by the UE on an uplink component carrier;
selecting a transmission power for each uplink transmission in the plurality of time-domain overlapping uplink transmissions, wherein selecting the transmission power for each uplink transmission includes scaling one or more of a maximum transmission power for each uplink transmission or an actual transmission power for each uplink transmission, the scaling based at least in part on a numerical quantity of the uplink transmissions in the plurality of time-domain overlapping uplink transmissions; and
performing the plurality of time-domain overlapping uplink transmissions on the uplink component carrier according to the selected transmission power for each uplink transmission.

2. The method of claim 1, wherein selecting the transmission power for each uplink transmission in the plurality of time-domain overlapping uplink transmissions comprises:
identifying a maximum available transmission power for the uplink component carrier; and
capping the transmission power for each uplink transmission to limit a sum of the actual transmission power for each uplink transmission within the maximum available transmission power.

3. The method of claim 2, wherein capping the actual transmission power comprises:
equally dividing the maximum available transmission power among each uplink transmission in the plurality of time-domain overlapping uplink transmissions.

4. The method of claim 2, wherein capping the actual transmission power comprises:
assigning a weighting factor to each uplink transmission; and
capping the actual transmission power for each uplink transmission according to the assigned weighting factor.

5. The method of claim 4, wherein capping the actual transmission power is based at least in part on an overlap between the uplink transmissions in a time domain.

6. The method of claim 4, wherein capping the actual transmission power is independent from an overlap between the uplink transmissions in a time domain.

7. The method of claim 1, further comprising:
receiving a signal configuring a maximum allowed transmission power for each uplink transmission.

8. The method of claim 1, further comprising:
cancelling one or more of the uplink transmissions based at least in part on a sum of the actual transmission power for each uplink transmission failing to satisfy a maximum available transmission power for the uplink component carrier.

9. The method of claim 1, further comprising:
scaling down the actual transmission power of each uplink transmission based at least in part on a sum of the actual transmission power for each uplink transmission failing to satisfy a maximum available transmission power for uplink component carrier.

10. The method of claim 1, further comprising:
scaling down the actual transmission power of one or more of the uplink transmissions based at least in part on a sum of the actual transmission power for each uplink transmission failing to satisfy a maximum available transmission power for the uplink component carrier.

11. The method of claim 1, further comprising:
scaling the transmission power for each uplink transmission according to a maximum available transmission power for each uplink transmission.

12. The method of claim 11, further comprising:
identifying the maximum available transmission power for each uplink transmission; and
scaling up the maximum transmission power for each uplink transmission to the maximum available transmission power.

13. The method of claim 11, further comprising:
identifying the maximum available transmission power for each uplink transmission based at least in part on a power class associated with time-domain overlapping uplink transmissions; and
scaling the maximum transmission power for each uplink transmission to the maximum available transmission power.

14. The method of claim 13, further comprising:
receiving a signal configuring a maximum allowed transmission power for each uplink transmission based at least in part on the power class.

15. The method of claim 1, wherein each uplink transmission in the plurality of time-domain overlapping uplink transmissions is associated with at least one of an antenna panel configuration of the UE, a control resource set pool index value of the UE, a node receiving the uplink transmission, a beam being used for the uplink transmission, or any combination thereof.

16. A method for wireless communication at a network entity, comprising:
transmitting a control message scheduling a plurality of time-domain overlapping uplink transmissions by a user equipment (UE) on an uplink component carrier, wherein a transmission power for each uplink transmission in the plurality of time-domain overlapping uplink transmissions is selected by scaling one or more of a maximum transmission power for each uplink transmission or an actual transmission power for each uplink transmission, the scaling based at least in part on a numerical quantity of the uplink transmissions in the plurality of time-domain overlapping uplink transmissions; and
receiving one or more uplink transmissions of the plurality of time-domain overlapping uplink transmissions on the uplink component carrier according to the selected transmission power for each uplink transmission.

17. The method of claim 16, further comprising:
transmitting a signal identifying a maximum allowed transmission power for the uplink component carrier, wherein the selected transmission power for each uplink transmission is based at least in part on the maximum allowed transmission power.

18. The method of claim 16, further comprising:
transmitting a signal identifying a weighting factor for each uplink transmission.

19. The method of claim 16, further comprising:
transmitting a signal identifying a maximum allowed transmission power each uplink transmission, wherein the selected transmission power for each uplink transmission is based at least in part on the maximum allowed transmission power.

20. An apparatus for wireless communication at a user equipment (UE), comprising:
a processor;
memory coupled with the processor; and
instructions stored in the memory and executable by the processor to cause the apparatus to:
receive a control message scheduling a plurality of time-domain overlapping uplink transmissions by the UE on an uplink component carrier;
select a transmission power for each uplink transmission in the plurality of time-domain overlapping uplink transmissions, wherein selecting the transmission power for each uplink transmission includes scaling one or more of a maximum transmission power for each uplink transmission or an actual transmission power for each uplink transmission, the scaling based at least in part on a numerical quantity of the uplink transmissions in the plurality of time-domain overlapping uplink transmissions; and
perform the plurality of time-domain overlapping uplink transmissions on the uplink component carrier according to the selected transmission power for each uplink transmission.

21. The apparatus of claim 20, wherein the instructions to select the transmission power for each uplink transmission in the plurality of time-domain overlapping uplink transmissions are executable by the processor to cause the apparatus to:
identify a maximum available transmission power for the uplink component carrier; and
cap the transmission power for each uplink transmission to limit a sum of the actual transmission power for each uplink transmission within the maximum available transmission power.

22. The apparatus of claim 21, wherein the instructions to cap the actual transmission power are executable by the processor to cause the apparatus to:
equally divide the maximum available transmission power among each uplink transmission in the plurality of time-domain overlapping uplink transmissions.

23. The apparatus of claim 21, wherein the instructions to cap the actual transmission power are executable by the processor to cause the apparatus to:
assign a weighting factor to each uplink transmission; and
cap the actual transmission power for each uplink transmission according to the assigned weighting factor.

24. The apparatus of claim 23, wherein capping the actual transmission power is based at least in part on an overlap between the uplink transmissions in a time domain.

25. The apparatus of claim 23, wherein capping the actual transmission power is independent from an overlap between the uplink transmissions in a time domain.

26. The apparatus of claim 20, wherein the instructions are further executable by the processor to cause the apparatus to:
receive a signal configuring a maximum allowed transmission power for each uplink transmission.

27. The apparatus of claim 20, wherein the instructions are further executable by the processor to cause the apparatus to:
cancel one or more of the uplink transmissions based at least in part on a sum of the actual transmission power for each uplink transmission failing to satisfy a maximum available transmission power for the uplink component carrier.

28. The apparatus of claim 20, wherein the instructions are further executable by the processor to cause the apparatus to:
scale down the actual transmission power of each uplink transmission based at least in part on a sum of the actual transmission power for each uplink transmission failing to satisfy a maximum available transmission power for uplink component carrier.

29. The apparatus of claim 20, wherein the instructions are further executable by the processor to cause the apparatus to:
scale down the actual transmission power of one or more of the uplink transmissions based at least in part on a sum of the actual transmission power for each uplink transmission failing to satisfy a maximum available transmission power for the uplink component carrier.

30. The apparatus of claim 20, wherein the instructions are further executable by the processor to cause the apparatus to:
scale the transmission power for each uplink transmission according to a maximum available transmission power for each uplink transmission.

31. The apparatus of claim 30, wherein the instructions are further executable by the processor to cause the apparatus to:
identify the maximum available transmission power for each uplink transmission; and
scale up the maximum transmission power for each uplink transmission to the maximum available transmission power.

32. The apparatus of claim 30, wherein the instructions are further executable by the processor to cause the apparatus to:
identify the maximum available transmission power for each uplink transmission based at least in part on a power class associated with time-domain overlapping uplink transmissions; and
scale the maximum transmission power for each uplink transmission to the maximum available transmission power.

33. The apparatus of claim 32, wherein the instructions are further executable by the processor to cause the apparatus to:
receive a signal configuring a maximum allowed transmission power for each uplink transmission based at least in part on the power class.

34. The apparatus of claim 20, wherein each uplink transmission in the plurality of time-domain overlapping uplink transmissions is associated with at least one of an antenna panel configuration of the UE, a control resource set pool index value of the UE, a node receiving the uplink transmission, a beam being used for the uplink transmission, or any combination thereof.

35. An apparatus for wireless communication at a network entity, comprising:
a processor;
memory coupled with the processor; and
instructions stored in the memory and executable by the processor to cause the apparatus to:
transmit a control message scheduling a plurality of time-domain overlapping uplink transmissions by a user equipment (UE) on an uplink component carrier, wherein a transmission power for each uplink transmission in the plurality of time-domain overlapping uplink transmissions is selected by scaling one or more of a maximum transmission power for each uplink transmission or an actual transmission power for each uplink transmission, the scaling based at least in part on a numerical quantity of the uplink transmissions in the plurality of time-domain overlapping uplink transmissions; and
receive one or more uplink transmissions of the plurality of time-domain overlapping uplink transmissions on the uplink component carrier according to the selected transmission power for each uplink transmission.

36. The apparatus of claim 35, wherein the instructions are further executable by the processor to cause the apparatus to:
transmit a signal identifying a maximum allowed transmission power for the uplink component carrier, wherein the selected transmission power for each uplink transmission is based at least in part on the maximum allowed transmission power.

37. The apparatus of claim 35, wherein the instructions are further executable by the processor to cause the apparatus to:
transmit a signal identifying a weighting factor for each uplink transmission.

38. The apparatus of claim 35, wherein the instructions are further executable by the processor to cause the apparatus to:
transmit a signal identifying a maximum allowed transmission power each uplink transmission, wherein the selected transmission power for each uplink transmission is based at least in part on the maximum allowed transmission power.
